(19) United States
(12) Patent Application Publication
(10) Pub. No.: US 2026/0237529 A1
(43) Pub. Date: Aug. 13, 2026

(54) DEVICE FOR THE IMPLEMENTATION OF ACCELERATED ION-BASED NUCLEAR FUSION REACTIONS

(71) Applicant: Bruno Sangle-Ferriere, Paris (FR)

(72) Inventor: Bruno Sangle-Ferriere, Paris (FR)

(21) Appl. No.: 17/980,956

(22) Filed: Nov. 4, 2022

(51) Int. Cl. G21B 1/03; G21B 1/17; G21B 1/19; G21B 1/21; G21B 1/23; H01M 12/06

(52) U.S. Cl. CPC G21B 1/03; G21B 1/17; G21B 1/19; G21B 1/21; G21B 1/23; H01M 12/06; H01M 2250/402

(57) ABSTRACT

A device for the implementation of nuclear fusion reactions, including an enclosure configured to contain a source material and a target, a system of at least partial ionization of the source material, an ion accelerator configured to accelerate the ionized source material to the target so as to cause the atomic nuclei of the ionized source material to fuse with atomic nuclei of the target, a heat recovery material in thermal contact with the target, and a system for converting the thermal energy recovered by the heat recovery material into electrical energy configured to supply at least part of the ion accelerator and/or ionization system.

### FIELD OF THE INVENTION

The present invention relates to the implementation of nuclear fusion reactions caused by the impact of an ion beam on a target.

By “nuclear fusion” is meant in the context of the invention a process by which two atomic nuclei assemble to form a heavier nucleus. This differs in particular from spallation, in which the nucleus hit by an incident particle decomposes due to the impact.

### BACKGROUND OF THE INVENTION

To date, the vast majority of atomic energy is produced by nuclear fission reactions that result in the creation of many unstable isotopes with half-lives that can be very large.

In addition, nuclear fission reactors often require significant time, such as several days, to be shut down. During this shutdown time, cooling may be required to prevent the remaining highly active fission products from triggering chain reactions.

Nuclear fusion is currently used in particular in the context of atomic weapons, combined in this case with nuclear fission reactions, and requires very high temperatures and pressures for the collision of nuclear nuclei to cause the fusion of these nuclei.

The implementation of controlled nuclear fusion reactions is therefore difficult. Nuclear fusion is a potentially clean and abundant source of energy.

It is known to cause the fusion of deuterium nuclei by subjecting them to a high voltage, of the order of 40 kV, in a vacuum chamber. However, this process triggers on the one hand the creation of neutrons and on the other hand does not recover the energy generated by fusion.

The EP application 2561514 A1 discloses a hybrid reactor, i.e. a nuclear fission reactor driven by a particle accelerator. According to the method described in this request, a proton flux is directed to a target to perform a spallation of nuclei of the target and thus produce neutrons to control the activity of the core of the nuclear reactor; and is therefore related to the use of accelerated particles to causing the spallation of nuclei, and not a nuclear fusion process.

There is therefore a need to propose a device for implementing nuclear fusion reactions between two nuclei which makes it possible to recover the energy released by such reactions and which does not require subjecting the reactants to conditions of high temperature and pressure.

The purpose of the invention is to meet at least partially this need.

### SUMMARY OF THE INVENTION

To do this, the invention relates, according to one of its aspects, a device for implementing nuclear fusion reactions, comprising:
an enclosure configured to contain a source material and a target,
an ionization system configured to at least partially ionize the source material,
an ion accelerator configured to accelerate the ionized source material to the target so as to cause the atomic nuclei of the ionized source material to fuse with atomic nuclei of the target,
at least one heat recovery material in thermal contact with the target, the heat recovery material being a thermally conductive material, preferably aluminum, copper or carbon nanotubes, and/or a heat transfer material, including air, water or liquid metal, and/or a heat absorbing material preferably absorbing heat by means of a chemical reaction or an endothermic phase change, the heat recovery material optionally comprising circulation channels of a heat transfer fluid,
a system for converting the thermal energy recovered by the heat recovery material into electrical energy configured to power at least part of the ion accelerator and/or ionization system.

The heat recovery material may also be used as the target.

The material created by the fusion of the source material with the target may have a significant speed at creation and itself fuse with some of the target material.

In advantageous version of the invention, the target material is circulated in a liquid or gaseous phase towards the heat recovery material.

In another advantageous version of the invention the accelerated ion is made to circulate close to an electrically conducting material such as a metallic grid acting as an electrode, from which electrons can be extracted to join the traveling ion making it electrically neutral before impacting the target material; alternatively, the target material arrives ionized on the target.

By “heat-conducting material”, is meant in the context of the invention a material in the solid state giving the thermal conductivity is greater than or equal to 5 W/m/K.

“Heat transfer material” means a fluid whose thermal conductivity is greater than or equal to 0.1 W/m/K and the heat capacity is greater than or equal to 0.1 KJ/kg/K.

“Heat-absorbing material” means a material that can react chemically or change phases endothermically by absorbing heat.

The source material is preferably an isotope of hydrogen: protium, deuterium or tritium, or a combination of said isotopes. Alternatively, the source material may be of higher atomic mass, for example, lithium, helium, fluorine, sodium, phosphorus, sulfur, bromine, potassium or neon. The higher atomic mass corresponds to a larger size of the nucleus and therefore to an increased probability of nuclear reaction by projection on a target.

Preferably, the source material is not deuterium if the target material is itself deuterium or tritium, nor tritium if the target material is itself deuterium. Indeed, these reactions produce neutrons.

Preferably, the source material and the target are chosen so that the isotopes resulting from the fusion reaction are stable. Alternatively, the source material and the target are chosen so that the isotopes resulting from the fusion reaction are unstable and decay by Decay Beta− or Beta+.

### Ionization

According to a particular embodiment, the ionization system of the source material comprises:
a laser,
an input waveguide configured to guide the light emitted by the laser to an optical input in the enclosure, with the optical input configured to allow illumination of the source material by the emitted light.

As indicated in the document “Laser stripping of hydrogen atoms by direct ionization”, E Brunetti et al., New journal of physics 17 053008 (2015), the laser can be configured to emit light where the instantaneous power is sufficient to allow the ionization of the source material. The ionization system may also have a wave concentrator configured to superimpose a plurality of cycles of the light emitted by the laser so as to increase the instantaneous power of the emitted light, the wave concentrator being preferably of the Coherent Amplification Network type. In addition, the device may advantageously comprise an output waveguide configured to guide light not absorbed by the source material from an optical output of the enclosure to the optical input of the said enclosure, and the enclosure may have a plurality of mirrors configured to reflect the light emitted by the laser between the optical input and the optical output so as to illuminate the source material several times.

According to an alternative embodiment, the ionization system may comprise an X-ray source configured to irradiate the source material.

Thus, the ionization of the source material is for example obtained by the irradiation of the source by X-rays produced by an X-ray tube placed in the enclosure containing the source material. The X-rays emitted by said tube preferably have a wavelength less than the energy of Planck's constant multiplied by the speed of light in a vacuum and divided by the ionization energy of the source material.

The ionization material is preferably heated to a temperature at which it is in the gaseous state. This is especially advantageous if it is sulfur, potassium, phosphorus, lithium or sodium.

### Acceleration

The ion accelerator is configured to accelerate ions obtained from the source material by electric fields, either in linear accelerators that can accelerate continuous ion flows with continuous voltages, or in cyclotrons or synchrotrons that can accelerate ion packets between two hollow electrodes where the positive and negative electrodes are alternating synchronously after the passages of the ions from one cavity to the other.

According to one embodiment, the ion accelerator is linear. The ion accelerator comprises a high-voltage generator, electrically connected to a first electrode arranged in the enclosure, preferably to a first end of the enclosure, and to a second electrode, the second electrode and the target being arranged in the enclosure preferably at a second end of the enclosure opposite to the first end; the generator and the first and second electrodes being configured to generate an electric field to accelerate the ionized source material to the target so as to cause the atomic nuclei of the ionized source material to fuse with atomic nuclei of the target.

According to an alternative embodiment, the ion accelerator comprises a cyclotron in which the ions produced by the ionization system enter, the ions being sent in packets into the cyclotron, preferably close to its center. The cyclotron is configured to accelerate the ionized source material to the target in such a way as to cause the atomic nuclei of the ionized source material to fuse with atomic nuclei of the target.

Alternatively again, the ion accelerator comprises a synchrotron into which the ions produced by the ionization system enter, the ions being sent in packets into the synchrotron, the magnetic field of the synchrotron being variable and being configured to confine the ionized source material in two half-tubes. The synchrotron is configured to accelerate the ionized source material to the target in such a way as to cause the atomic nuclei of the ionized source material to fuse with atomic nuclei of the target. Ions can leave the synchrotron to reach the target for example by removing the magnetic field used to rotate the ions between two rectilinear elements of said synchrotron, ions then continuing into a straight trajectory instead of rotating in the following element

The Internal walls of the cyclotron or synchrotron as well as the walls of the optional maintenance electrodes described below, are advantageously covered with dielectric layers, for example polymers or glass resistant to electric fields resulting from the potential difference applied to the two D shaped electrodes of the cyclotrons or the two tubes of the synchrotrons. The slowdowns of the ions due to the Bragg effect require, to be compensated, when the target is solid, electric fields of intensity greater than the dielectric resistances of most of the electrical insulators. The slices of target materials are therefore advantageously spaced by a ratio of 15 that is to say 15 times their thickness so that a smaller electric field can allow the source ions to resume a sufficient speed before their entry into the next slice of target material. Alternatively, the pressure of the target, if it is gaseous, is such that the electric field necessary to compensate for the Bragg effect does not damage the electrical insulators used such as quartz glass.

According to an alternative embodiment, the ion accelerator comprises a combination of linear accelerators and cyclotrons or synchrotrons. Thus, the ions from a first linear accelerator are for example injected into a cyclotron near its center to be directed at the exit to a second linear accelerator. The ions, if they are injected into the cyclotron with a speed of which the component along the axis of the cyclotron is non-zero are preferably slowed down in this direction by an electric field of the same direction and but in opposite way generated by electrodes located close to or surrounding of the center of the cyclotron thereby allowing to cancel this component of the velocity while the ions are still circulating in this zone.

The ion accelerator is preferably empty of gas, that is, with a pressure of less than 10⁻⁵ bar. This advantageously avoids the Bragg effect of slowing down the ions. Thus, the ion accelerator is preferably protected at the entrance and exit of each of its components (linear accelerator, cyclotron, synchrotron) by membranes permeable to ions and impermeable to gases present outside and equipped with one or more pumps to create an empty vacuum within the said components of the ion accelerator. The ion accelerator is then preferably configured so that the so-called membranes can be replaced episodically or continuously, such membranes being able to be degraded through nuclear reactions with the accelerated ions or simply by heating due to the ions that pass through them.

The device according to the invention may comprise one or more of the following optional features:
the device comprises one or more coils surrounding the accelerated ion beam, acting as magnetic lenses to concentrate or keep the ion beam concentrated,
the system for converting thermal energy into electrical energy of the device is selected from a zinc cell or a hydrogen fuel cell associated with a system for the production of hydrogen from thermal energy,
If the target material is solid, it can be placed on a ribbon or a moving surface to transport the target and possibly the material formed by the nuclear reaction to a cooling bath from where it can also possibly be cleared of the material generated during the nuclear reaction or undergo a supply of target material.
if the source material is solid or liquid, the enclosure preferably comprises a support made of a light-transparent material and configured to support said source material,
if the source material is gaseous, the enclosure preferably comprises a gas inlet and a gas outlet configured to allow the circulation of a source material in gaseous form between the gas inlet and the gas outlet so that the path of the source material crosses the path of the ionization light,
the enclosure comprises a membrane permeable to the ionized source material and impermeable to the neutral source material and arranged between the first and second electrodes, the membrane preferably consisting of a plurality of layers of hexagonal boron nitride,
the device preferably comprises a coil arranged around the enclosure and centered on an axis passing through the crossing of the path of the source material and the path of the ionizing light, the coil being configured to generate a magnetic field tending to keep the ionized source material in the axis of the electric field of acceleration,
the input and output waveguides are optical fibers, the optical input and the optical output of the enclosure each preferably having a lens and an anti-reflective layer,
the inner wall of the enclosure is at least partially covered with dielectric material,
if the target material is liquid or gaseous and the material produced by the nuclear reaction is liquid or solid, the device is preferably configured so that the ions are projected, from top to bottom, towards the target material so that the material produced can descend below the target material for recovery.
the device preferably comprises an intermediate electrode arranged between the first electrode and the target and connected to a second generator itself connected to the second electrode, the intermediate electrode consisting of a grid and/or a conductive membrane, for example made of graphene coated by a dielectric,
The device preferably comprises, close to the target, a membrane permeable to ions and allowing to maintain around the target a pressure sufficient so that it or the product of the nuclear reaction does not evaporate in the rest of the enclosure, but can preferably be evacuated.

According to an advantageous variant of the invention, the target material circulates in liquid or gas phase to the heat recovery material.

In another advantageous variant of the invention, the device comprises an electrically conductive material, such as a metal grid, arranged along the path of the accelerated ions and configured to act as an electrode from which electrons can be extracted to neutralize the accelerated ions, making the latter electrically neutral before impacting the target material. Alternatively the target material arrives ionized on the target.

The invention also relates but without restriction:
a use of the device according to the invention to implement the fusion of deuterium or protium as a source material and aluminum 27 as a target.
a use of the device according to the invention for the production of hydrogen by thermolysis from the iodine sulfur cycle, the iodine sulfur cycle being fed by the heat recovered by the heat-conducting material.
a use of the device for the production of electricity
a use of the device for heating water or water vapor
a use of the device as a chemical reactor for heating the chemical product allowing their reaction, with or without catalyst, in the enclosure containing the target material
a use of the system for the reduction of carbon dioxide to carbon and oxygen
use of the system for the regeneration of zinc dioxide into zinc and oxygen

### BRIEF DESCRIPTION OF THE DRAWINGS

FIG. 1 represents schematically and partially a first embodiment of the device according to the invention.

FIG. 2 is a detail view of part of the device in FIG. 1.

FIG. 3 illustrates a second embodiment of the device according to the invention.

FIG. 4 represents a device according to the invention associated with a hydrogen generation device.

FIG. 5 represents a light switch used in an embodiment of the device.

FIG. 6 shows an embodiment of the device that uses a cyclotron.

### DETAILED DESCRIPTION

### Device

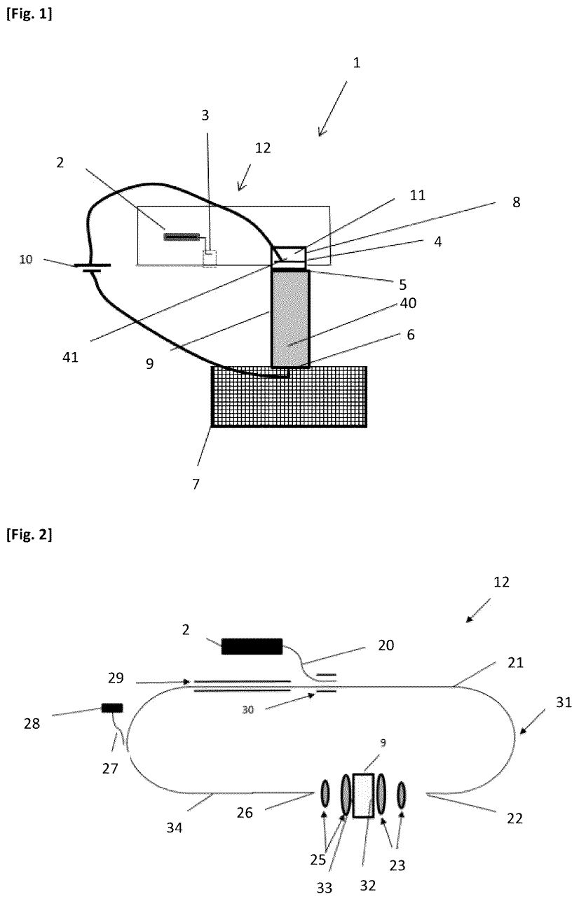

As illustrated in FIG. 1, the device 1 for implementing nuclear fusion reactions according to the invention comprises an ionization system 12 of a source material 11, an enclosure 9 configured to contain the source material 11 and a target material 6, and a high voltage generator 10. The device could also include a first enclosure configured to hold the source material and a second enclosure configured to contain the target material.

The ionization system 12 is configured to ionize at least part of the source material 11. Once ionized, the source isotopes are accelerated under the effect of the voltage generated by generator 10 between electrodes 4 and 6.

In the embodiment illustrated, the electrode 6 consists of the target material. The target is aluminum-27, the source is deuterium and the product silicon-29.

In order to accelerate the source isotopes sufficiently to allow the fusion of the accelerated source isotopes with nuclei of the target, the voltage generated by the generator 10 can be between 240 kV and 2.4 million volts.

The heat generated by exothermic fusion reactions is advantageously recovered by a heat-conducting material 7 in thermal contact with the target material 6. The heat conductor 7 is for example based on aluminum, copper or carbon nanotubes. Channels can advantageously be formed in heat conductor 7 to allow the circulation of a heat transfer fluid.

In solid form, the target 6 and/or the heat-conducting material are preferably arranged on a removable tray so as to allow their replacement. Alternatively, the target in solid form and/or the heat-conducting material are arranged in the form of plates or films in such a way as to allow their continuous renewal, for example in the form of a tape of target material scrolling continuously, for example at constant speed, under the ion beam.

### Source Elements and Target Elements

It is possible to use as source and target isotopes many pairs of preferably stable isotopes which, by fusing, form a stable isotope. Among the possible reactions in the context of the invention, a non-exhaustive list of examples of pairs of isotopes of source nuclei and target nuclei as well as the isotopes formed during their fusion is given in Table 1, with their respective neutron numbers and atomic numbers N and Z. “Stable isotope” means an isotope with a half-life of more than 10¹² years.

Isotopes other than those mentioned in Table 1 may be used in the context of the invention. Thus, the source isotope may also be deuterium obtained by the Girdler process and the target isotope may be aluminum-27 in liquid or solid form, the nuclear fusion reaction being exothermic and producing silicon-29. The source can also be helium 4 and the target of tungsten 186 to produce platinum 195, the reaction being exothermic or the source being helium 4 and the target of iridium 193, and the product of gold 197.

The invention may also allow the simultaneous use of one or more different source isotopes as well as the use of one or more different target isotopes.

Source isotopes can be introduced into the enclosure in gaseous, solid or liquid form.

### Complex Targets

The invention may also authorize the use as a target of materials consisting of complex molecules, that is to say molecules composed of several different elements. The use of complex molecules such for instance organic molecules, as target elements makes it possible in particular to use target elements in gaseous form while, not associated with other elements, they may only be available in solid or liquid form at ordinary temperatures thus facilitating the evacuation of the heat produced, but also to use the heat produced by the nuclear reaction within the gaseous target, and also allow one or more chemical reactions.

### Reaction Chambers Containing a Catalyst

The enclosure containing the target element may also contain catalysts, preferably located on the edges of said enclosure so as not to interact with the source ions, allowing direct use of the heat from the slowing of the ions and the fusion reaction(s) to allow chemical reactions between the molecules forming the target.

TABLE 1

| Isotope1 | N1 | Z1 | Isotope2 | N2 | Z2 | Isotope3 | N3 | Z3 |
|---|---|---|---|---|---|---|---|---|
| Tritium | 2 | 1 | Nitrogen 14 | 7 | 7 | Oxygen 17 | 9 | 8 |
| Tritium | 2 | 1 | Fluorine 19 | 10 | 9 | Neon 22 | 12 | 10 |
| Tritium | 2 | 1 | Sodium 23 | 12 | 11 | Magnesium 26 | 14 | 12 |
| Deuterium | 1 | 1 | Nitrogen 14 | 7 | 7 | Oxygen 16 | 8 | 8 |
| Deuterium | 1 | 1 | Fluorine 19 | 10 | 9 | Neon 21 | 11 | 10 |
| Deuterium | 1 | 1 | Sodium 23 | 12 | 11 | Magnesium 25 | 13 | 12 |
| Deuterium | 1 | 1 | Aluminum 27 | 14 | 13 | Silicon 29 | 15 | 14 |
| Helium-4 | 2 | 2 | Carbon 12 | 6 | 6 | Oxygen 16 | 8 | 8 |
| Fluorine 19 | 10 | 9 | Lithium 7 | 4 | 3 | Magnesium 26 | 14 | 12 |
| Helium-4 | 2 | 2 | Bore 11 | 6 | 5 | Nitrogen 15 | 8 | 7 |
| Fluorine 19 | 10 | 9 | Bore 11 | 6 | 5 | Silicon 30 | 16 | 14 |
| Fluorine 19 | 10 | 9 | Carbon 12 | 6 | 6 | Phosphorus 31 | 16 | 15 |
| Nitrogen 14 | 7 | 7 | Nitrogen 14 | 7 | 7 | Silicon 28 | 14 | 14 |
| Oxygen 16 | 8 | 8 | Carbon 12 | 6 | 6 | Silicon 28 | 14 | 14 |
| Neon 20 | 10 | 10 | Bore 11 | 6 | 5 | Phosphorus 31 | 16 | 15 |
| Helium-4 | 2 | 2 | Fluorine 19 | 10 | 9 | Sodium 23 | 12 | 11 |
| Neon 20 | 10 | 10 | Carbon 12 | 6 | 6 | Sulphur 32 | 16 | 16 |
| Nitrogen 14 | 7 | 7 | Fluorine 19 | 10 | 9 | Sulphur 33 | 17 | 16 |
| Fluorine 19 | 10 | 9 | Nitrogen 14 | 7 | 7 | Sulphur 33 | 17 | 16 |
| Fluorine 19 | 10 | 9 | Fluorine 19 | 10 | 9 | Argon 38 | 20 | 18 |
| Oxygen 16 | 8 | 8 | Fluorine 19 | 10 | 9 | Chlorine 35 | 18 | 17 |
| Fluorine 19 | 10 | 9 | Oxygen 16 | 8 | 8 | Chlorine 35 | 18 | 17 |
| Chlorine 37 | 20 | 17 | Bore 11 | 6 | 5 | Titanium 48 | 26 | 22 |
| Phosphorus 31 | 16 | 15 | Bore 11 | 6 | 5 | Calcium 42 | 22 | 20 |
| Bromine 81 | 46 | 35 | Lithium 7 | 4 | 3 | Strontium 88 | 50 | 38 |
| Fluorine 19 | 10 | 9 | Sodium 23 | 12 | 11 | Calcium 42 | 22 | 20 |
| Fluorine 19 | 10 | 9 | Neon 20 | 10 | 10 | Potassium 39 | 20 | 19 |
| Neon 20 | 10 | 10 | Fluorine 19 | 10 | 9 | Potassium 39 | 20 | 19 |
| Oxygen 16 | 8 | 8 | Oxygen 16 | 8 | 8 | Sulphur 32 | 16 | 16 |
| Fluorine 19 | 10 | 9 | Aluminum 27 | 14 | 13 | Titanium 46 | 24 | 22 |
| Helium-4 | 2 | 2 | Oxygen 16 | 8 | 8 | Neon 20 | 10 | 10 |
| Oxygen 16 | 8 | 8 | Neon 20 | 10 | 10 | Argon 36 | 18 | 18 |
| Neon 20 | 10 | 10 | Oxygen 16 | 8 | 8 | Argon 36 | 18 | 18 |
| Oxygen 16 | 8 | 8 | Sodium 23 | 12 | 11 | Potassium 39 | 20 | 19 |
| Neon 20 | 10 | 10 | Neon 20 | 10 | 10 | Calcium 40 | 20 | 20 |
| Fluorine 19 | 10 | 9 | Chlorine 37 | 20 | 17 | Iron 56 | 30 | 26 |
| Helium-4 | 2 | 2 | Sulphur 32 | 16 | 16 | Argon 36 | 18 | 18 |
| Oxygen 16 | 8 | 8 | Magnesium 24 | 12 | 12 | Calcium 40 | 20 | 20 |
| Helium-4 | 2 | 2 | Chlorine 37 | 20 | 17 | Potassium 41 | 22 | 19 |
| Chlorine 35 | 18 | 17 | Lithium 7 | 4 | 3 | Calcium 42 | 22 | 20 |
| Tin 122 | 72 | 50 | Neon 20 | 10 | 10 | Neodymium 142 | 82 | 60 |
| Tin 123 | 73 | 50 | Neon 20 | 10 | 10 | Neodymium 143 | 83 | 60 |
| Tin 124 | 74 | 50 | Neon 20 | 10 | 10 | Neodymium 144 | 84 | 60 |

### Fusion of Target and Source

Thus, according to the invention, the ions are accelerated at a sufficient speed so that at impact with the target, the kinetic energy accumulated by the ions allows the nuclei of the accelerated ions and the target to fuse. The speed of ions and the intensity of electric fields depend in particular on the source and target materials.

The target can be the final destination of the source ions that stop there, slowed down by said target or merging with it. It can be solid: it is for example made of aluminum 27, the source ions can then be deuterium to form beryllium. The target can also be carbon 12, the source ions being then for example neon 20 to form sulfur 32. The target can also be liquid or gaseous, for example consisting of oxygen-16, the source of neon-20, or chemical compounds formed from these elements for instance carbon dioxide. The target may also include chemical compounds from the recombination of the elements produced or elements produced in combination with source ions and/or target elements. Chemical reactions from such chemical compounds can take place, depending on the isotopes produced by unstable elements. Other source and target materials can be used.

In the case of a linear ion accelerator, the last electrode(s) of the accelerator before the impact of the ions with the target (in other words, the electrodes closest to the target) can be arranged within the target, especially if it consists of matter in the gaseous or liquid state. The last electrodes can also include the target. Finally, the last electrodes can be separate from the target, the target being preferably arranged in the immediate vicinity of the last electrode.

### Ion Velocity Maintenance

Ions are slowed down as they enter the target, whether it is solid, liquid or gaseous. It is therefore possible to ensure the presence of an electric field within the target opposing the slowing down of said ions, especially if the target is not electrically conductive. It is therefore possible to have at its ends or within it one or more maintenance electrodes configured to maintain the constant speed of the ions despite the effects that induce their slowdown. If the target is electrically conductive, a dielectric body is preferably available on either side of the maintenance electrode so that electrons are not extracted from it. If the target is solid, it can be arranged in several strips on either side of said maintenance electrodes.

Alternatively or in combination, if the ions of the ionized source material are grouped in packets, a cyclotron can be configured to maintain their speed or to accelerate them as they move from one cyclotron die to another. The ions can then enter the cyclotron, preferably already accelerated by an acceleration cyclotron or by a linear accelerator, from outside the cyclotron, the target ensuring its deceleration until the first pass between the two D shaped electrodes, if said target is, all or partly outside this zone between the two D shaped electrodes. Alternatively, and preferably if neither the target, nor the product are electric conductors, the target may be placed between the two D shaped electrodes, the electrostatic force between the two said D shaped electrodes compensating for the Bragg effect of the ions passing through the target material. The target is also preferably placed at the periphery of the cyclotron thereby allowing the acceleration of the ions near its center, and allowing the nuclear reaction at its periphery.

The source element chlore 35, can thus be projected on the target element lithium 7 to form calcium 42, with an energy efficiency, according to the calculations of the inventor, higher than if the device did not use an intermediate electrode.

### Collector's Electrodes

The electrons extracted from the last electrodes, i.e. the conductive electrodes closest to the target, are advantageously used to complete the element produced by the nuclear fusion reaction, if no conductive electrode is placed before the target to complete the ion into a full element, before its impact with the target. If the elements produced are in liquid or gaseous form, the said conductive electrodes are preferably placed, on either side of the element produced, so-called collector's electrodes, electrically conductive, which are configured to attract the ions produced during the nuclear reaction and which, being heavier than the source ions, have, at their creation, a longitudinal velocity lower than the said source ions and are therefore not necessarily contained in the ion beam maintained by a possible longitudinal magnetic field. These electrodes are advantageously made of tungsten or lanthanum hexa-boride (LaB₆) since the electrons are extracted easily of said collection electrodes when they are heated respectively to more than 2200° C. and 1500° C.

These collection electrodes, and/or the target, are preferably connected to the electrodes of the ion accelerator by a voltage generator allowing the circulation of electrons from the electrode closest to the place of formation of the source ions to the target or collection electrodes. The electrode or electrodes closest to the collection electrode are preferably connected to said collection electrodes by an electrical device allowing them to have an electrical potential greater than the potential of the collection electrodes thus favoring the migration of target ions to said collection electrodes; if, as in the case of a cyclotron or synchrotron, there are potential differences between a plurality of acceleration electrodes, the collection electrodes may have different and lower potentials than other electrodes but are close. If the accelerator is linear and accelerates the ions continuously, the potential difference between the collection electrodes and the electrode close to the source can be large, this potential difference being then greater than the acceleration voltages of the ions. These collector electrodes are preferably permeable to the product of the nuclear reaction, especially if it is gaseous, or optionally to the mixture of the target element and the element produced, to allow the evacuation of the elements produced, but also optionally, by the evacuation of the target elements, of the heat produced by the nuclear reaction and the slowing down of the source ions. These electrodes can also be made up, followed or preceded by semi-permeable membranes allowing only the desired product to pass through, or followed by valves to adjust the flow of gas through it.

If the target and the product are liquid or solid and the target is dielectric, that is to say not electrically conductive, the collection electrode, for example consisting of a heated grid consisting of tungsten or lanthanum hexa boride (LaB₆) is advantageously placed in front of the target and therefore also in front of the fusion product to be able to bring the electrons allowing the ions produced to neutralize their electric charge and become atoms in their own right. The device is preferably arranged to allow the replacement of said collection electrodes.

If the collection electrode is behind the target without touching it, said target can accumulate positive charges until electrons are extracted from the collection electrode, the accumulation of positive charges also creating an electric field in the opposite direction of the traveling ions. The velocity of the source ions is therefore preferably large enough for the ionized isotopes to reach the target and generate the fusion reaction despite the presence of the electric charge accumulated by the target.

If the target is gaseous, the device advantageously comprises a membrane permeable to ions and impermeable to the gaseous target allowing the ions to be accelerated in a vacuum before reaching the target. This membrane consists for example of 6 layers of graphene, graphane, or hexagonal boron nitride.

### Nonlinear Trajectory of Ions in a Linear Accelerator

The path travelled by the ions source in the target can be several meters, even if the target is solid if it is cut into slices between which are arranged maintenance electrodes. In order to make the target more compact one can advantageously place within it or, for solid targets for example, between the slices of the target material, magnetic fields generated preferably by solenoids, these magnetic fields perpendicular to the direction of the ions and allowing them to rotate to reach the next maintenance electrode which is then no longer necessarily in the axis of the previous one. These solenoids to rotate the particle beam can be tracked and/or preceded by magnetic lenses to keep the ion beam focused. An assembly of for example 15 of these coils and maintenance electrodes on a snail path then makes it possible to organize the path of the source ions in a more compact circuit.

### Cyclotron and Maintenance Synchrotron

Alternatively, the ions are produced in packets and sent into a cyclotron or synchrotron, the target material being optionally but not necessarily arranged between the two half-cylinder-shaped electrodes (commonly called “D shaped electrode”) of the cyclotron, or between the half torus of the synchrotron and if it is not solid, possibly being held there by membranes permeable to the source ions, the slowing down of the ions being compensated by the electric field between the two D shaped electrodes or the two half torus. The input velocity of the source ions is preferably higher than the speed allowing their fusion with the target material. The target material if it is located between the two D shaped electrodes is preferably located in the cyclotron but at its periphery, the speed of the ions being there the greatest. Solid, it can be replaced by the continuous or intermittent renewal of the blades that compose it; liquid or gaseous, it can be replaced by a flow of the same nature entering and leaving the space reserved for the target by orifices arranged around the perimeter of the cyclotron or synchrotron.

### Combined Cyclotron for Both Acceleration and Fusion

The target can be arranged in a cyclotron used for the acceleration of ions. In this case a wall preferably of dielectric material but impermeable to the target gas or gases that may result from the heating of the target or the product, is advantageously arranged inside the cyclotron, said wall or some of its parts where the packages of ions can cross the being permeable to ions. The intensity of the electric field between the two D shaped electrodes or the two tubes is advantageously modulated to first accelerate the ions to the speed allowing fusion all along the crossing of the target material, then stabilized so that the ions can cross a plurality of times this target material, preferably until they are exhausted by the fusion reactions, a new packet of ions that can then advantageously penetrate the cyclotron. In this variant, the ions being introduced close to the center of the cyclotron with a speed perpendicular to the plane of rotation of cyclotron, electrodes are preferably placed above and below the cyclotron which allow to decelerate the ions in this vertical direction until canceling this vertical speed when they leave the electric field created by these electrodes. “Vertical direction” means the direction perpendicular to the plane in which the ions circulate in the cyclotron.

The ionization chamber may also be advantageously located in the center of the cyclotron, between the two D shaped electrodes, or on a particular orbit of the synchrotron, preferably circumscribed by a cylindrical membrane of revolution around the axis of the cyclotron or synchrotron especially if the target and source elements are different; electrons detached from the source elements being alternately attracted by the walls of one and then the other D shaped electrode or half tube.

### Isotope Source Ionization System

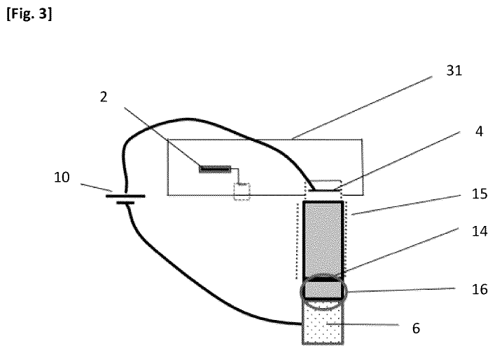

The ionization system 12 of the embodiment illustrated in FIG. 1 is detailed in FIG. 2.

In this example, the ionization system 12 comprises a laser 2. The light produced by the laser is guided by the feed waveguide 20 to a reinsertion circuit 31.

The power waveguide 20 is for example a single-mode optical fiber.

The power waveguide 20 can also be a rectangular and narrow waveguide, the width and thickness is for example a fifth of the wavelength of the laser light. The light is preferably linearly polarized and its electric field perpendicular to the plane of the waveguide which brings the light near the optical fiber or a larger waveguide, for example of the thickness and width twice the wavelength of the light. That larger waveguide or optical fiber carrying light between the optical output and input of the enclosure. The narrow waveguide approaches the large waveguide, preferably making an arc of a circle. This approach is preferably unique; alternatively, the light from the laser or concentrator is first divided to be divided into several narrow waveguides each approaching the large waveguide or optical fiber. Such approaches can be advantageously done on both sides of the said large waveguide or optical fiber.

The reinsertion circuit 31 includes an input waveguide 21 configured to guide the light flowing through the reinsertion circuit 31 to an optical input 32 of the enclosure 9.

The input waveguide 21 can be a single-mode optical fiber and has a 22 end which is advantageously covered with an anti-reflective layer and its end is cut and polished in the shape of a lens.

Preferably, a first set of focusing lenses 23 covered with anti-reflective layers is arranged between the end 22 of the input waveguide and the optical input 32 of the enclosure 9.

Alternatively, to the use of an anti-glare layer, the system can be configured so that the light output from end 22 of the input waveguide respects the Brewster angle, thus avoiding partial reflection of the light at the interface of end 22 and the ambient environment (atmosphere or partial vacuum).

Once the light enters enclosure 9 through optical input 32, some of the light generated by the laser interacts with source material 11 in enclosure 9 in such a way as to ionize the isotopes of the source material.

However, another part of the light is likely to pass through enclosure 9 without interacting with source isotopes. In order to recover this un-absorbed light, Enclosure 9 may also have an optical output 33 configured to recover the aid un-absorbed light in Enclosure 9.

The light can optionally be reflected back into the enclosure by one or more mirrors before reaching the optical output 33.

Preferably, a second set of focusing lenses 25 is arranged between the optical output 33 and the end 26 of an output waveguide 34 to facilitate its insertion in the waveguide 34.

Optical coupling between optical output 33 and end 26 can be achieved in the same way as optical coupling between optical input 32 and end 22.

The output waveguide 34 is optically connected to the input waveguide 21 to form the reinsertion circuit 31.

According to a particular embodiment, the input and output waveguides can form a single single-mode optical fiber.

A wave concentration device, such as a device allowing mode locking could be integrated into the laser for the purpose of superimposing different cycles of a coherent light wave and thus reducing its duration while increasing its instantaneous power.

The duration of a pulse at the output of the wave concentration device advantageously corresponds to a length of the pulse of the order of the wavelength of the coherent wave produced by the laser;

the pulse is advantageously repeated at a chosen frequency so that the particles accelerated by a pulse have reached the target before a new pulse accelerates particles.

The wave concentration device used is known as such. It can be of the Coherent Amplification Network type as described in the presentation “ICAN and 100 GeV's Ascent”, J. Mourou et al., EuroNNAC, CERN Meeting, 3 May 2012.

Ionization systems using an ionization process other than laser can also be used in the context of the invention.

### Reinsertion Circuit

The reinsertion circuit 31, between end 26 of the output waveguide and end 22 of the input waveguide, allows the reuse of light passing through enclosure 9 without interacting with source isotopes.

In a first embodiment, preferably, the sum of the optical paths traversed by the light wave, that is to say the sum of the distances traveled in each medium multiplied by the refractive in D shaped electrodes of said media, in a complete optical loop (for example a loop starting and ending at end 22 of the input waveguide) is a multiple the integer of the wavelength in the vacuum of the light circulating in the insertion circuit 31.

The length of some elements in the loop is likely to vary, for example due to temperature variations. An element with adjustable properties can advantageously be introduced into the loop to control the optical length of the loop.

The adjustable properties of an element can be for example the length of said element or its refractive index.

In the case where the waveguides are optical fibers, it is possible, for example, to lengthen a segment of optical fiber by piezoelectric materials or by judiciously chosen temperature-sensitive material such as iron.

Alternatively, a waveguide segment can be composed of a material, such as lithium niobate, having a refractive index adjustable according to physical quantities such as an external electric field, so as to form a Pockels cell.

Thus, adjustment electrodes 29 connected to an electric generator can advantageously be arranged around a waveguide segment of refractive index adjustable according to an electric field in order to adjust the refractive index of the segment and thereby adjust the optical length of the reinsertion circuit 31.

It is also advantageous that the power waveguide 20 has a segment with an adjustable refractive index, especially in the case where the reinsertion circuit 31 circulates a light in a wave packet rather than a continuous light. In the embodiment illustrated in FIG. 2, the secondary adjustment electrodes 30 make it possible to adjust the refractive index of a segment of the power waveguide 20 to allow the introduction of light from the laser 2 at a time judiciously chosen according to the phase of the wave circulating in the waveguide 20.

FIG. 5 shows a light switch 70 that can advantageously be used if the wave packet is very compact, as opposed with the above-described reinsertion circuit. This switch allows for the light to circulate in a second embodiment of the reinsertion circuit being a loop most of the time while still allowing for the loop to be broken and instead to accept light from an incoming light source. Switch 70 includes a birefringent prism 71, or alternatively a birefringent blade, as well as electrodes 72 configured to apply an electric field to the Pockels cell of prism 71. This makes it possible to modify the optical refractive index of the prism 71 to control the path of light in the prism. In a first case, the input laser light 73 is directed to the ionization chamber to form the output beam 75. In a second case, the light 74 recycled by the reinsertion circuit, entering the prism 71 with an angle different from that of light 73, can also be directed to the ionization chamber by the same output beam 75 thanks to the modification of the refractive index of the prism 71 by means of electrodes 72. Preferably, the reinsertion circuit 31 comprises a control section comprising a waveguide 27 configured to collect a small fraction, for example 0.1%, of the light circulating in the Reinsertion circuit and to direct it to a photocell 28. This advantageously makes it possible to measure the luminous flux circulating in the Reinsertion circuit.

It is then possible to adjust, according to the measurements made by the photocell 28, the properties of the element having adjustable properties to keep the length of the optical path of the light of the insertion circuit 31 constant and to maintain a maximum luminous flux intensity.

Alternatively, the reinsertion circuit 31 may also comprise an optical amplifier, for example by erbium-doped fiber, by Raman effect or by semiconductor amplifier.

The power waveguide 20 is configured to inject light from laser 2 into the reinsertion circuit 31 as in its first embodiment.

Preferably, the reinsertion circuit is implemented in its first embodiment when the wave train circulating in the reinsertion circuit is at least twice as long as the length of said circuit, to allow part of the light wave passing through the power waveguide 20 to couple to the light wave circulating in the reintegration circuit.

As described earlier, it is possible that the laser light is concentrated by a wave concentration device, for example of the mode locking type. It is thus possible to obtain concentrated wave trains, having for example a length of about 1000 times the wavelength of the laser light, the wave trains being for example separated by a time between 50 ms and 500 ms. In this case, since the light circulating in the reinsertion circuit in its second embodiment is composed of discontinuous wave trains, the reinsertion circuit 31 may take the form of a single continuous waveguide with one end at end 22 and the other at end 26. The intake waveguide 20 is then configured to transmit the light from the laser to the insertion circuit 31 at the moment when a wave train passes through the waveguide and to decouple from the circuit 31 moreover, the coupling and decoupling being done for example by modification, under the effect of an electric field produced by the electrodes 30, of the refractive index of the waveguide 20 for its part close to circuit 31.

The reinsertion circuit preferably comprises one or more waveguides close to the waveguide from the enclosure or going to the enclosure to measure its intensity or intensity by collecting a portion of the luminous flux circulating there, in the direction of the light coming from the laser or concentrator, but also in the opposite direction, as some light rays may have been reflected in the various optical devices.

### Laser of the Ionization System

In the embodiment represented in FIG. 1 as well as in that represented in FIG. 2, the source isotopes are ionized by a laser.

The wavelength of the light produced by the laser is for example 369 nm, 269 nm or 182 nm. The wavelength produced can also be smaller, with lasers with wavelengths as small as 13.5 nm being known.

Light can be produced by laser diodes. One can also use a continuous wave laser such as VECSELs.

The wavelength 369 nm can for example be obtained by mixing a laser light of 1470 nm with the second harmonic of a laser light of 985 nm.

The wavelength 269 nm can be obtained using the third harmonic of a laser light of wavelength 808 nm.

The wavelength 182 nm can be obtained by mixing the fifth harmonic of a laser light of 1064 nm with a laser light of 1260 nm. The mechanisms for obtaining harmonics and wavelength mixtures are for example described in application WO 2018/128963 A1.

According to a particular embodiment, the laser is used in combination with a mode locking device or a compressed pulse device to reduce the duration of laser pulses by increasing their instantaneous power, such as a Coherent Amplification Network type device.

The laser beam can be enlarged or focused by optical lenses so that the power per unit area of the laser beam does not exceed the dislocation limits of certain materials used in the ionization device.

The size of the lenses is advantageously chosen to allow the focus of the laser beam on a sufficient length in compartment 41 where the ionization of the source takes place and then reach the lenses 25 of the reinsertion circuit.

The frequency of light produced by the laser can be doubled or quadrupled by passing through well-chosen nonlinear and non-symmetrical crystals. The frequency can also be multiplied by five using a harmonic generation process whereby the laser beam passes through a rare gas such as argon.

One can also use a coherent light of 361 nm produced by a gallium nitride laser diode GaN, bandgap width 3.44 eV; or a coherent light of 188 nm produced by a laser with indium gallium nitrite (InGaN) to which the proportion of gallium is chosen to produce a bandgap semiconductor material of width 3.3 eV, whose frequency is doubled by passing through a crystal, for example a borate fluoride crystal such as KBe₂BO₃F₂ (KBBF) which is transparent at wavelengths as small as 147 nm and supports powers up to 9·10¹¹ W/cm².

One can also use a coherent light of 166 nm produced by a quantum well laser or by a process of generating harmonics by passing two laser beams generated by a titanium sapphire laser in argon gas at a pressure of 440 mb.

However, only part of the laser light subjected to frequency multiplication processing is likely to see its frequency actually modified, especially if the generation of harmonics is done in a gaseous medium.

It is therefore advantageous to implement another reinsertion circuit similar to the reinsertion circuit 31 previously described to recycle the light intended to generate the production of harmonics. The separation between the increased frequency light and the initial frequency light can be done by means of dispersive prisms or Bragg filters.

Wave trains produced with a laser in combination with a locked mode is repeated at frequencies that can be between 0.1 kHz and 10 KHz. However, the first reinsertion circuit for discontinuous wave trains as described above and illustrated in FIG. 2 has the effect of circulating the wave in a loop and therefore repeating the wave trains at frequencies equal to the speed of light in the circuit divided by the total length of the circuit.

The light circulating in the reinsertion circuit for discontinuous wave trains is likely to lose power by attenuation between two successive pulses, due to a degree of opacity of the materials guiding the light and its crossings of the ionization chamber.

The reinsertion circuits can only reinsert light with a wavelength greater than 150 nm, as few glasses or crystals are transparent at smaller wavelengths.

### Enclosure

Enclosure 9 is configured to contain both source and target isotopes.

Enclosure 9 can be divided into compartment 41 to contain the source isotopes and allow their ionization, and into an acceleration duct 40 in which the ionized isotopes are accelerated to target 6.

In particular, if the source isotopes are in gaseous form, enclosure 9 may comprise a watertight compartment 41 in which the pressure is preferably adjustable so as to adjust the intensity of the flow of accelerated source nuclei to target 6.

As described below, it is also possible that compartment 41 forms part of a source gas circuit.

Compartment 41 may have a secondary electrode connected to a secondary generator and configured to drive the isotopes ionized between electrode 4 and itself, and then allow their acceleration to target 6. The place of ionization of the source isotopes can be separated from the secondary electrode or electrode 6 by a membrane permeable to ions and impermeable to the source gas, for example made of graphene or graphane. The membrane can be made for example by a plurality of sheets of graphene, hexagonal boron, or graphane arranged on a grid to produce a large membrane. If the material is conductive, such as graphene, it is preferably electrically isolated from the electrodes so that it cannot electrically neutralize the ions.

Preferably, the enclosure 9 is surrounded at the level of the source isotopes, that is to say at the level of compartment 41, by a coil 8 configured to generate a magnetic field, preferably between 0.1 T and 10 T, of axis parallel to the electric field generated by the generator 10 and tending to keep the ionized isotopes in the axis of the coil. Coil 8 is centered on an axis passing through the crossing of the path of the source material and the path of light.

This magnetic field prevents the ionized isotopes from moving longitudinally in a direction other than the direction of acceleration defined by the electric field generated by the generator 10 between electrodes 4, 6. This limits the contact of the ionized isotopes with the walls of enclosure 9, while keeping the ionized isotopes close to the axis of the electric field.

In the embodiment of FIG. 1, the enclosure 9 comprises a membrane 5 permeable to ionized isotopes but impermeable to isotopes in gaseous form to prevent the passage of the source gas in the acceleration channel 40. It may be an assembly of six layers of hexagonal boron nitride known as such, as described in “Vapor-liquid-solid growth of large-area multilayer hexagonal borion nitride on dielectric substrates”, Z. Shi et al., Nature communications, 11(1), 1-8, 2020 and in “Large Area Monolayer Hexagonal Boron Nitride on Pt foil”, J. H. Park et al., Acs Nano, 8(8), 8520-8528, 2014.

Thus, the membrane 5 is arranged in the acceleration channel 40 near the compartment 41. The location of membrane 5 is chosen so that the value of the electric field at membrane 5 is below the breakdown threshold of the source gas, this threshold depending on the pressure of the gas and can be evaluated using Paschen's law.

The ionized isotopes are accelerated in the acceleration duct 40 by the electric field generated by the generator 10. Since ionized isotopes generate a radial electric field, i.e. orthogonal to the axis of the acceleration duct 40, some ionized isotopes can be deflected outwards from the acceleration duct 40. In this case, and as illustrated in FIG. 3, it is advantageous to provide a coil 15 surrounding the acceleration channel 40 and configured to generate a magnetic field tending to hold the ionized isotopes in the axis of coil 15, which can be the same as the axis of the acceleration duct 40. The magnetic field generated can for example be between 0.1 T and 10 T.

The calculations made by the inventor show that the deviation of the ionized isotopes due to the electric field generated by the ionized isotopes can be small, depending on the configuration of the device in particular thanks to the influence of the magnetic field generated by coils 8 and 15. In this case, care should preferably be taken to size the acceleration duct 40 so that the ionized isotopes cannot reach the inner walls of the acceleration duct 40. Similarly, the field applied by the coil around enclosure 9 can help keep the ion beam forming in enclosure 9 around the acceleration axis and the size of membrane 5 can be sized so that all accelerated ions can pass through it.

Electrode 6 is preferably arranged at a precise distance from electrode 4, this distance depending in particular on the number of ionized isotopes projected on target 6 per unit of time and the maximum electric field tolerated in enclosure 41.

### Acceleration Duct

The ions produced by the ionization of the source material are accelerated by an electric field generated by the generator 10 between electrodes 4, 6. Due to the slowing down of the ions in the target material, the kinetic energy of the ions is, for the deuterium ions projected on lithium 7 preferably of the order of 3.5 times the energy created by the fusion reaction or about 60 MeV, thus allowing the penetration of said ions into the target. For the nuclear reaction where protium ions are projected onto gaseous tritium, maintenance electrodes being installed in the core of the target tritium, the speed of the ions entering the target material is preferably of the order of 500 times the minimum kinetic energy allowing the nuclear reaction, i.e. 15 MeV, the slowdown due to the Bragg effect being less at these speeds.

The axis of the electric field is preferably orthogonal to the path of light ionizing the source isotopes, when ionization is carried out by laser.

Electrodes 4 and 6 are not necessarily of the same geometry or dimensions, so the field lines of the electric field are not necessarily parallel to each other.

The ionized isotopes are accelerated between electrodes 4 and 6 in an acceleration duct 40 of enclosure 9.

As the isotopes are electrically charged, the inner wall of the acceleration channel is advantageously composed or coated with a dielectric material, thus preventing the wall from yielding electrons.

The target material 6, solid or liquid is, in the example illustrated in FIG. 1, arranged at one end of the enclosure 9 and the acceleration channel 40 opposite to that where is located the source 11 and form the electrode 6. The target material can also be placed on a conductive support forming electrode 6.

As illustrated in FIG. 3, the device according to the invention optionally comprises an intermediate electrode 14 that is located in the acceleration channel 40, between electrodes 4 and 6. The intermediate electrode makes it possible to reduce the acceleration and therefore also the speed of the ions in the ionization chamber, in particular to prevent, as in the case of deuterium that they react together unclearly; the intermediate electrode may also channels the electric field lines and allows the acceleration of the ionized isotopes to the intermediate electrode before the field lines either diverge towards the electrode 6, or be diverted to electrode 6 which can be placed in an axis different from the axis of acceleration binding electrode 4 to the intermediate electrode, the ions can also be deflected by a non-longitudinal magnetic field. The use of an intermediate electrode can also make it possible to have a different acceleration of the ions after said intermediate electrode 14, especially if the ions must be accelerated with a voltage greater than 60 million volts.

Thus, the target can be subjected to a bombardment of directed and concentrated ionized isotopes.

The intermediate electrode 14 is for example formed by a grid with square shaped meshes having e a length of the order of one centimeter and a thickness of the order of a millimeter and coated with a dielectric. Some ions travelling through the wires of the grid may lose their positive charge by doing so.

The intermediate electrode 14 is electrically connected to the electrode 6 by a voltage generator where the voltage is judiciously chosen according to the distance between electrodes 6 and 14.

A coil 16 configured to generate an adjustable magnetic field adapted to deflect ionized isotopes can advantageously be arranged between the intermediate electrode 14 and the target 6. The magnetic field generated by coil 16 can be adjusted to allow the ionized isotope beam to scan a surface of target 6 or to choose the area of target 6 to be impacted by the ionized isotope beam.

Magnetic lenses such as those used in television cathode ray tubes can also be used to focus and direct the beam of ionized isotopes.

### Acceleration of Ionized Isotopes

The electric field generated by generator 10 between electrodes 4 and 6 accelerates the ionized isotopes. Generator 10 is configured to generate high voltages, for example above 30,000 V and less than 80,000,000 V allowing nuclear fusion and, preferably, allowing ion speeds to minimize the energy lost to the Bragg effect. The generator 10 is for example formed of generators marketed by the company Genvolt under the name of Perseus and mounted in series.

Electrode 4 is preferably placed in compartment 41.

It can also be placed in the acceleration duct 40, for example between compartment 41 and membrane 5. This advantageously limits contact with the source gas in order to avoid the appearance of breakdown effects of the source gas. In this case, electrode 4 is preferably formed by a porous and conductive membrane, for example made of graphene or organometallic graphene.

Electrode 6 is the target or a support for it, especially if the target is not conductive.

Electrode 4 is conductive, which allows it to conduct and evacuate electrons produced by the ionization of source isotopes.

If the ions are produced outside the electric field, they remain surrounded by electrons that oscillate around and ensure the electrical neutrality of the whole. The ions must thus migrate, driven by their thermal agitation until they are in the electric field which then attracts electrons to the cathode and ions to the anode.

To avoid the accumulation of ions at low speeds, the electric field in the ionization zone is preferably chosen high though below the value that can cause the breakdown of the ionized gas. The electric field can par for example have a value of 4 10⁵ V/m, the gas can be ionized over a significant thickness, especially if the section of the light ray of illumination is important, the acceleration voltage of the ions is preferably chosen so that even the ions produced closest to the membrane are accelerated to the speed allowing them to fuse with the target.

### Sources of Materials in Gaseous Form

The source gas can be introduced into the ionization chamber by means of a pressure regulator. However, when the source isotopes are in gaseous form and are consumed by ionization in volumes and at rates that do not allow their homogeneous replacement, or to prevent ions from being produced at an unwanted distance from electrode 4, or to concentrate the production of ions in the electric field, the source gas is preferably brought into enclosure 9 via a first pipe whose end in enclosure 9 forms a nozzle. The gas is then preferably sucked into a second pipe arranged in the axis of the nozzle of the first pipe. The end of the second pipe overlooking enclosure 9 is preferably formed into a funnel. The entrance of the acceleration duct 40 of the ions is then preferably near the intersection of the gas jet and the path of light from the optical input 32 within the enclosure 9.

The first and second pipes are preferably connected to a pump to accelerate the flow of gas through the pipes, as well as to a reserve of the source gas to introduce the latter into the device and add as it is consumed.

The source gas then circulates in a gas circulation circuit.

A filtration device for filtering the circulating gas to remove impurities can advantageously be arranged in the gas circulation circuit.

A device configured to produce a vacuum in the compartment of enclosure 9 where the gas circulates and optionally to reintroduce the source gas into the circuit can advantageously be used.

### Antineutron Protections

If the target materials are likely to produce neutrons, a protective wall capturing neutrons is preferably arranged around the device.

The protective wall capturing neutrons may contain a material slowing down neutrons such as water, preferably below its critical temperature of 374° C., or calcium hydride CaH₂, preferably below its melting temperature of 816° C., in which are immersed tubes or beads of boron or tubes containing helium 3. A thickness of 10 cm of water makes it possible to divide by about 2.7 the number of fast neutrons passing through the protection.

### Gamma Radiation Protection

The chamber where fusion occurs but also the ionization chamber and the antineutron protection if neutrons are likely to be produced, are preferably surrounded by a protective wall absorbing gamma ray. Such a wall is for example composed of lead with a thickness of 35 cm or tungsten with a thickness of 21 cm, in order to protect the environment from gamma rays that nuclear reactions produce and to convert them into heat.

One can also use an iridium wall.

The protection against gamma rays is preferably cooled by an internal circulation of a heat transfer liquid or chemical compounds described above reacting endothermically to cool said radiation protection, capture the energy from the nuclear reaction, transform said energy in chemical energy or perform one or more desired chemical transformations.

The liquids circulating in the gamma-ray protection also absorb gamma rays. The thickness of the gamma radiation protection is preferably calculated so that the dose of radiation escaping from the device annually, and at any time, does not exceed the regulatory limits of health protection.

### Geometry of Protections

In addition, a configuration allowing the deviation of the trajectory of the ions in their acceleration beam using magnetic fields and optionally intermediate electrodes is preferably used in order to protect the environment and possibly the gamma ray ionization chamber. For example, the ions produced in the ionization chamber can bypass a gamma-ray protective wall separating the nuclear reaction chamber from the ionization chamber.

The configuration can be further improved by passing the ion beams through a non-straight cavity arranged in the gamma-absorbing material in such a way that no gamma ray can go in a straight line from its place of production to the entrance to the pipe. The same applies to other cavities allowing, for example, to evacuate the material produced, especially if they are gaseous and have only a low absorption power of gamma rays.

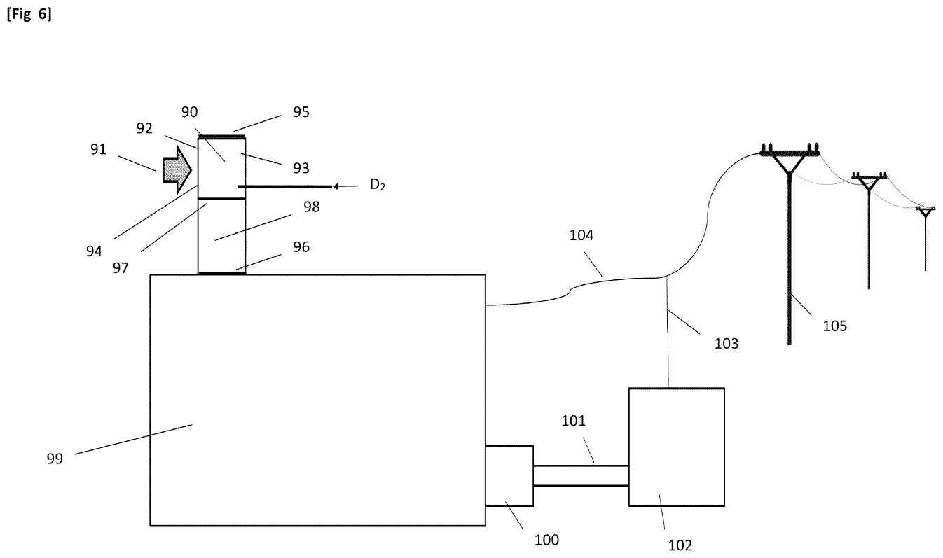

FIG. 6 shows an embodiment of the invention. The device shown consists of an ultraviolet ionization system 90, ionizing di-deuterium. The ionization system comprises a vacuum chamber of square section and covered inside a dielectric coating, supplied with Di-deuterium D₂, and containing said di-deuterium at a pressure of 0.1 atm. The ionization system also includes a 182 nm ultraviolet pulse laser 91 as described in the article “Laser stripping of hydrogen atoms by direct ionization”, E Brunetti et al., New Journal of Physics 17 053008 (2015), configured to illuminate di-deuterium. One side of the enclosure has a window closed by hexagonal boron nitride 97 that allows deuterium ions to pass through, another side of the enclosure has a window closed by RbBa₂(PO₃)₅ 92 that allows ultraviolet light to pass through. The ionization system also has a conductive electrode 95 arranged on the inner face of the enclosure opposite the boron nitride window. The ions thus exit the ionizer through the hexagonal boron nitride window 97 to be led into a vacuum tube 98 guided by an electric field applied cyclically and created by an electrode, for example in the form of a grid coated with a dielectric material 96, located at the outlet of said tube, towards the entrance of a cyclotron 99. The cyclotron can be as built for the MEDICYC cancer research program in Nice and described in 1984 at the 10th International Conference on Cyclotrons and their Applications. It is configured to accelerate protons to energies of 60 MeV and may be adapted by changing its operating frequency and maximum radius, to the acceleration of ionized deuterium D+. The ionized deuterium is then directed into a vacuum chamber 100 in where the target material is located, preferably lithium 7 in the liquid state between 181° C. and 1330° C. Advantageously, lithium 7 liquid is also used as a heat transfer liquid supplying heat through a circulation circuit 101 to an electricity generator 102 comprising a water vapor turbine and an alternator that supplies the electrical network 105 through a cable 103.

Advantageously, the electricity generator 102 also supplies the cyclotron and the ionization system by the electrical connection 104. A potential difference is applied between the electrode internal to the ionization system and the one coated in dielectric material located at the end of the tube, itself electrically connected to the target, to attract ions to said end. This potential difference is preferably applied intermittently in a synchronized way with the cyclotron so that the ions arrive there in packets at the beginning of their acceleration phase.

### Anti-X-Ray Protections

Compartment 41 where the ionization of the source takes place, the laser 2 and the reinsertion circuit 31 are advantageously protected by a stainless-steel wall, for example having a thickness between 1 mm and 5 mm, in particular 2 mm, if the wavelength of the light used for ionization is less than 100 nm.

X-rays may be produced in particular in a plane perpendicular to the acceleration or deceleration of the ions, in the nuclear reaction chamber due to the deceleration of the ions, or during their deviation in particular if the reaction chamber is in a cyclotron or synchrotron. Gamma ray protection advantageously protects against these X-rays if the deceleration or acceleration takes place in the enclosure containing the target material; however, special protection must be placed around other places where such acceleration and decelerations may take place, in particular around the ion accelerator and around the synchrotron and cyclotron.

### Sensors

Sensors controlling in particular the deformation, temperature and acceleration of the structures of the device and in particular anti-gamma radiation protection devices are advantageously used to stop the acceleration and/or production of ions before it heats up abnormally or loses some of its protections, in particular those against gamma rays and anti-neutrons.

### Heat Absorbing Material and Complex Targets

### Hydrogen Production by Sulfur-Iodine Cycle

When the fusion reactions between the source isotopes and the target isotopes are exothermic, the heat released by the fusion can be recovered by the heat-conducting material 7.

Advantageously, the heat-conducting material 7 can be a chemical reactor wall. In particular, a chemical reactor can be used for the production of hydrogen by thermolysis using a sulfur-iodine cycle: see the presentation “Sulfur-Iodine Thermochemical Cycle”, P. Pickard, Sandia National Labs, May 17, 2006. An oxide-cerium cycle can also be implemented.

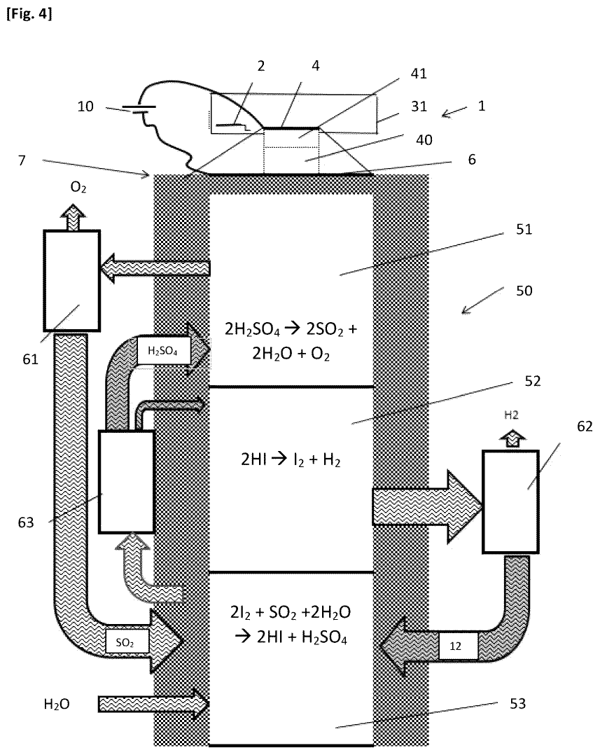

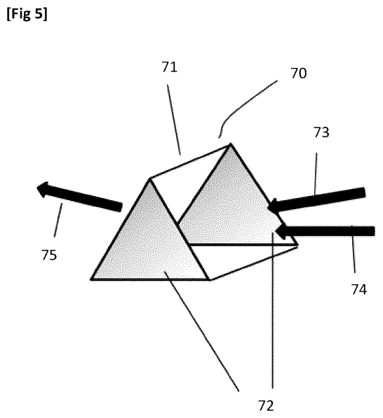

FIG. 4 illustrates a device 1 for implementing fusion reactions according to the invention associated with a device 50 for producing hydrogen by thermolysis.

The heat produced by the fusion reactions is transported by the heat-conducting material 7 in reactors 51, 52, 53 since the internal temperatures are maintained at 830° C., 650° C. and 120° C. respectively. Reactors 51 and 52 on the one hand and 52 and 53 on the other hand share a wall respectively, the other walls of the reactors being formed by the heat-conducting material 7.

In operation, H₂O water is introduced into reactor 53. Mixed with iodine gas 12 and Sulphur dioxide SO₂, the water reacts to produce hydrogen iodide HI and sulfuric acid H₂SO₄ which are then separated in separator 63.

After separation, hydrogen iodide is injected into reactor 52 and sulfuric acid into reactor 51.

In reactor 52, hydrogen iodide reacts to produce dihydrogen H₂ and iodine I₂. Dihydrogen and iodine are separated in separator 62. After separation, the dihydrogen is evacuated and the iodine is reintroduced into reactor 53.

In reactor 51, sulfuric acid reacts to produce sulfur dioxide SO₂, water H₂O and oxygen O₂. A separator 61 is provided to separate the products from the reaction. The sulfur dioxide is then injected into reactor 53 and the oxygen is evacuated.

Heat-conducting material 7 can also be connected to a heating plant or heat exchanger coupled to a turbine to generate electricity or mechanical energy, thus forming a motor.

### Creation of Rare Earths

The device for implementing fusion reactions according to the invention may be used to produce rare earths or rare elements, such as neodymium from tin and neon. In this example tin can be used as the target to the nuclear reaction and neon as source material.

### Water Heating

The process described can also be used to heat water, in liquid or gaseous form. Water can therefore be used as heat absorbing material. Water, the formula of which being H₂O can also be used as a complex target. For example, a source of fluorine 19 or sodium 23 accelerated to 1.5 MeV can be used to react with oxygen O 16 and protium H to form with fluorine chlore 35, neon 20, and with sodium magnesium 24 and potassium 39.

### Olefin Production

The heat of fusion and Bragg effect is advantageously used to convert with the help of for example of platinum, palladium, rhodium, ruthenium, iridium, osmium, an alkane such as butane to an alkene, and therefore butane to butene. Olefin can therefore be used as heat absorbing material or a reactant in the reactor used as heat conducting material. Alternatively one can use nuclear fusion on the alkane the formula of which being CₙH₂ₙ₊₂ to heat it with for example source of fluorine 19 or Sodium 23 accelerated to 1.5 MeV to react with carbon 12 and protium to form respectively, with the fluorine of phosphor 31 and neon 20, and with sodium 23, of chrome 35 and magnesium 24.

### CO2 Reduction

The heat of fusion and Bragg effect is advantageously used to transform carbon dioxide mixed with dihydrogen into methane and water or to transform methane into carbon and dihydrogen according to the following reactions:

CO₂+4H₂->CH₄+2H₂O at 30 atm and 400° C. in the presence of nickel

CH₄->C+2H₂ if the methane is heated to 1200° C. in the presence of diamonds on which the carbon is deposited to increase its size. The same reaction may occur at 800° C. with iron as catalyst or at 900° C. with carbon as catalyst as described in the article “Methane Pyrolysis for Zero-Emission Hydrogen Production: A Potential Bridge Technology from Fossil Fuels to a Renewable and Sustainable Hydrogen Economy”, Sanchez-Bastardo et al., Ind. Eng. Chem. Res. (2021), 60, 32, 11855-11881.

Carbon dioxide being for example heated by a fusion reaction with tritium or lithium 7.

The methane is heated for example by a nuclear fusion reaction using deuterium for source ions.

A mix of CO₂ and dihydrogen, as well as methane can therefore both be used as heat absorbing material or complex target or as reactants within the chemical reactor forming the conducting material 7.

### Plastics Recycling

In another variant, plastics can also be used as heat absorbing material and/or complex target or as reactants within the chemical reactor forming the conducting material 7. Plastics may include plastic waste, including polystyrene, polyethylene, polypropylene, polyterephthalate that are brought in, preferably in melted form in the reactor under the ion beam made fluorine 19 being used as a source to fuse with nitrogen, hydrogen, carbon or oxygen, which in addition to the heat of the cooling of the ions, heat the interior of the reactor in which a catalyst such as heat-treated zeolite and acid will have been advantageously placed [Miandad, R., Rehan, M., Barakat, M. A., Aburiazaiza, A. S., Khan, H., Ismail, I. M., . . . & Nizami, A. S. (2019). Catalytic pyrolysis of plastic waste: towards pyrolysis-based biorefineries. Frontiers in Energy Research, 7, 27.], to break down said plastics, into gasoline at about 450° C., the excess heat being evacuated via a steam turbine generating electricity a part is used to accelerate the source ions. Alternatively, the source ion used may be sodium-23, especially if the nitrogen has been removed from the atmosphere surrounding the plastic.

### Manufacture of Cement

A mix of clay and limestone can be used as absorbing material and nitrogen as heat transfer material or target. The heating of clay and limestone can be carried out by a flow of nitrogen heated by nuclear reaction, for example bromine 81 or magnesium 25 preferably raised to a temperature where it is in the gaseous state before its ionization, accelerated respectively to 3.5 Mev and 2 Mev being used as a source material on nitrogen, to form molybdenum and potassium.

### Zinc Oxide Calcination

Zinc oxide can be used as a heat absorbing material at 1727° C. Oxygen can be separated from zinc for example by bringing the gas mixture to a pressure such that the partial pressure of zinc gas reaches the pressure at which said zinc gas becomes liquid is about 30 GPa; thereby allowing regeneration of zinc-air battery electrode.

### Hydrogenation of Zinc Oxide

Protium can be used as a source and tritium as a target, with protium accelerated to 30 MeV. The heat absorbing material can be a mix of zinc oxide and dihydrogen; thereby allowing the regeneration of zinc-air batteries electrodes. The chemical reaction is:

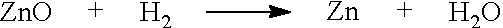

This reaction can be done at 1000° C. in a mixture of 87% di-nitrogen, 13% hydrogen but preferably without di-nitrogen and preferably in the absence of water [see the article Lew, S., Sarofim, A. F., & Flytzani-Stephanopoulos, M. (1992). Reduction of zinc titanate and zinc oxide solids. Chemical Engineering Sciences, 47(6), 1421-1431]. Zinc oxide can come from a zinc-air fuel cell thus recharging the fuel of such a fuel cell which can also optionally be rechargeable by electrolysis. Zinc, used with hydrogen, can be used in part to produce the electricity needed to accelerate the ions that allow the nuclear reaction, and the excess heat produced can be used to generate hydrogen through the sulfur iodine ring.

The invention is not limited to the examples described above. In particular, the devices and processes mentioned or illustrated may be combined differently with each other to form other unillustrated variants.

1. A device for implementing nuclear fusion reactions, comprising:
an enclosure configured to contain a source material and a target,
an ionization system configured to at least partially ionize the source material,
an ion accelerator configured to accelerate the ionized source material towards the target so as to cause the atomic nuclei of the ionized source material to fuse with atomic nuclei of the target,
at least one heat recovery material in thermal contact with the target, the heat recovery material being a heat-conductive material, and/or a heat transfer material,
a system configured to convert thermal energy recovered by the heat recovery material into electrical energy configured to power at least in part the ion accelerator and/or ionization system.

2. The device according to claim 1, wherein the device is configured so that the accelerated ionized source material passes close to an electrically conducting material acting as an electrode, such that electrons are extracted from the electrically conducting material to join the accelerated ionized source material.

3. The device according to claim 1, wherein the ionization system of the source material comprising:
a laser,
an input waveguide configured to guide the light emitted by the laser to an optical input of the enclosure, the optical input being configured to allow the illumination of the source material by the emitted light.

4. The device according to claim 4, further comprising an output waveguide configured to guide an amplified light not absorbed by the source material to the optical input of the enclosure from an optical output of the said enclosure.

5. The device according to claim 4, wherein the enclosure comprising a support made of a transparent material to the light emitted by the laser and configured to support a source material in solid form.

6. The device according to claim 4, wherein the input and output waveguides being optical fibers.

7. The device according to claim 1, wherein the ion accelerator comprising a high voltage generator (10), electrically connected to a first electrode arranged in the enclosure, and to a second electrode, the second electrode and the target being arranged in the enclosure, the generator and the first and second electrodes being configured to generate an electric field to accelerate the ionized source material to the target so as to cause the atomic nuclei of the ionized source material to fuse with atomic nuclei of the target.

8. The device according to claim 1, wherein the system for converting thermal energy into electrical energy being selected from a zinc battery or a hydrogen fuel cell associated with a system for producing hydrogen from thermal energy.

9. The device according to claim 1, wherein the enclosure comprising a gas inlet and a gas outlet configured to allow the circulation of a source material in gaseous form between the gas inlet and the gas outlet.

10. The device according to claim 1, wherein the enclosure comprising a membrane permeable to the ionized source material and impermeable to the neutral source material and arranged between the first and second electrodes.

11. The device according to claim 1, further comprising a coil arranged around the enclosure, the coil being configured to generate a magnetic field tending to hold the ionized source material in the axis of the electric field of acceleration.

12. The device according to claim 1, wherein the inner wall of the enclosure being at least partially covered with a dielectric material.

13. The device according to claim 1, further comprising an intermediate electrode arranged between the first electrode and the target and connected to a second generator connected to the second electrode.

14. The device according to claim 1, wherein the source material and the target being chosen so that the product of the fusion reaction is a stable isotope.

15. The device according to claim 1, wherein the source material and the target being chosen so that the product of the fusion reaction is an unstable isotope decaying by β⁻ decay or by β⁺ decay.

16. The device according to claim 1, wherein the heat recovery material is a heat-conducting material.

17. The device according to claim 17, wherein the heat-conducting material constitutes at least part of a wall of a chemical reactor.

18. The device according to claim 1, wherein the source material is neon and the target is tin.

19. The device according to claim 1, wherein the heat recovery material is a heat-absorbing material.

20. The device according to claim 20, wherein the heat-absorbing material is chosen among water, olefin, a mix of carbon dioxide and dihydrogen, methane, plastics, dinitrogen, zinc oxide, a mix of zinc oxide and dihydrogen, sulfuric acid H₂SO₄, and hydrogen iodide HI.

21. A method of use of the device according to claim 1, comprising a step consisting in providing deuterium as the source material and lithium 7 as the target.
